(19) United States
(12) Patent Application Publication
(10) Pub. No.: US 2005/0141900 A1
(43) Pub. Date: Jun. 30, 2005

(54) Free-propagation optical transmission system

(75) Inventors: Jean-Paul Pocholle, La Norville (FR); Daniel Dolfi, Orsay (FR); Carlo Sirtori, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/498,904

(22) PCT Filed: Dec. 10, 2002
(86) PCT No.: PCT/FR02/04268

(30) Foreign Application Priority Data
Dec. 18, 2001 (FR) 01/16389

(51) Int. Cl. G01B 9/02; H04B 10/04

(52) U.S. Cl. 398/186; 356/450

(57) ABSTRACT

The present invention relates to a system for optical transmission in free propagation mode of one digital data signal in the atmosphere, with autocompensation of the turbulence effects. It applies especially to optical telecommunications. According to the invention, the system comprises light emission means and optoelectronic detection means suitable for detection around one given non-zero detection frequency. The emission means simultaneously emit, for each signal to be transmitted, two light waves at least one of said waves being intensity-modulated by said signal. Detection then takes place at a detection frequency equal to the difference between said frequencies of the light waves emitted.

The present invention relates to a system for optical transmission in free propagation mode and applies especially to optical telecommunications.

In the field of optical telecommunications, it is necessary in certain types of application to seek direct optical communication in free propagation mode in the atmosphere. Apart from the lower cost, transmission by optical beams in free propagation mode makes it possible to dispense with an array of optical fibers, thereby opening up the spectral range over which data can be transmitted and provides greater transmission stealth.

Conventional systems for optical transmission in the atmosphere use either direct detection, or heterodyne detection. However, it turns out that turbulence effects in the atmosphere greatly penalize the transmission, by disturbing the wave plane.

For a direct detection system, the turbulence effects result in a spatial fluctuation of the beam, which results in its focusing properties at the photodetector being degraded. Signal failing may even be observed, due to displacement of the beam in the focal plane, the surface of the photodetector being finite and its position fixed. This effect is all the greater in the case of high transmission data rates, the area of the sensitive surface of the detector having to be smaller.

FIG. 1 illustrates by a diagram the principle of heterodyne or coherent detection. Heterodyne detection consists in superimposing, at the detector DET, a wave W₀ of angular frequency ω₀, output by a local oscillator LO, with the carrier wave W₁ of angular frequency ω₁ that conveys the modulation signal to be transmitted (angular frequency ωₘ). This operation amounts to mixing, in the detector, two waves of angular frequencies ω₀ and ω₁+ωₘ, which makes it possible, thanks to suitable filtering in the detector, to increase the signal-to-noise ratio considerably. As is apparent in FIG. 1, the carrier wave W₁ emitted by optical emission means SRC and receiving the modulated electrical signal S(t) to be transmitted has, after free propagation in the atmosphere, a distorted wavefront. This results in greatly altered heterodyne mixing and reduced transmission efficiency. The only possibility for improving the detection would therefore consist in using a dynamic and adaptive system for shaping the wavefront of the local oscillator, which would make the system much more complex.

The present invention overcomes the aforementioned drawbacks by proposing a system for optical transmission in free propagation mode in the atmosphere with autocompensation of the turbulence effects.

To do this, the invention proposes a system for the optical transmission in free propagation mode of at least one digital data signal, comprising light emission means and optoelectronic detection means suitable for detection around at least one given non-zero detection frequency, characterized in that said emission means simultaneously emit, for each signal to be transmitted, two light waves at two different respective optical frequencies, at least one of said waves being intensity-modulated by said signal, and in that at least one of said detection frequencies is equal to the difference between said frequencies of the light waves emitted.

The transmission system makes it possible, thanks to autocompensation of the turbulence effects, to perform a wide-field heterodyning function which increases the detection effectiveness.

Other advantages and features will become more clearly apparent on reading the description that follows, illustrated by the appended figures which show:

FIG. 1, a transmission system with heterodyne detection according to the prior art (already described);

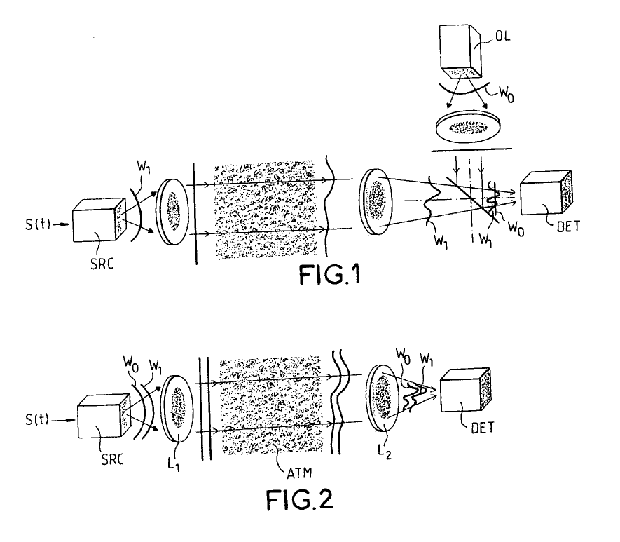

FIG. 2, a transmission system according to the invention;

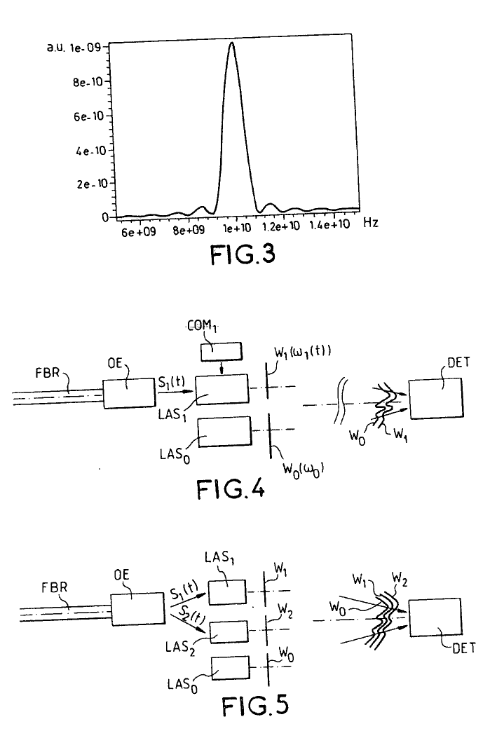

FIG. 3, the form of a filter for the detection means according to the invention;

FIG. 4, a diagram illustrating an encrypted transmission system according to the invention; and

FIG. 5, a diagram illustrating a transmission system according to the invention for performing a multiplexing function.

In the figures, identical elements are denoted by the same reference numerals.

FIG. 2 describes by way of a simplified diagram the principle of the system for optical transmission in free propagation mode according to the invention.

The system according to the invention especially comprises light emission means SRC that simultaneously emit, for each digital data signal S₁(t) to be transmitted, two light waves denoted by W₀ and W₁, also called carrier waves, with respective different angular frequencies ω₀ and ω₁, corresponding to different optical frequencies v₀ and v₁ respectively. It will be recalled that angular frequency ω₀, frequency v₀ and wavelength λ₀ are connected by the equation:
ω₀=2πv₀=2πc/λ₀ (1)
where c is the velocity of light.

According to the invention, at least one of said waves is intensity-modulated by the signal S₁(t). A shaping optic, for example L₁, is used to form two plane waves that propagate freely through the disturbed propagation medium, for example the atmosphere, the latter being shown symbolically by the reference ATM in FIG. 2. The waves are then collected by a collection optic L₂. According to the invention, the transmission system furthermore includes optoelectronic detection means DET suitable for detection around at least one detection frequency equal to the difference Δv=v₁−v₀ between the frequencies of the emitted light waves. Thus, by using two optical carrier waves W₀ and W₁ at emission, with digital encoding by the presence or absence of one or both optical carrier waves, the transmission system allows autocompensation of the turbulence effects. This is because the two waves simultaneously emitted follow the same optical paths and undergo the same turbulence effects. The spatial phase variations that result from the local deformations of the wavefront are thus compensated for in the detection means, resulting in an improvement in the detection effectiveness, as will be explained below.

The emission means SRC are, for example, formed by a two-frequency laser source, the feasibility of which has been demonstrated for example by C. Gmachl et al. in “Quantum cascade lasers with a heterogeneous cascade: two-wavelength operation” (APL, Vol. 79, No. 5, p. 572, 2001). Such a source allows simultaneous emission of two waves of different wavelengths, the light emission intensities of which may be temporally modulated by an external electrical signal. When such a source is used, the two emitted waves are simultaneously modulated by the data signal S₁(t) to be transmitted.

The emission means may also be formed from two independent laser emitters, the light emission intensity of each of the emitters of which may be temporally modulated by an external electrical signal; these are, for example, laser diodes. These two emitters may be temporally synchronized with each other in order to simultaneously deliver the coding of the signal to the emission or, as will be seen later, one of the emitters may emit continuously, only the light emission intensity of one of the emitters being modulated by the data signal to be transmitted.

We will now explain in greater detail the principle of the transmission system according to the invention, assuming that the emission means SRC emit two waves Wⱼ(j=0 or 1) of angular frequency ωⱼ in the form of plane waves, the associated fields of which may be written as:
\overline{E}ⱼ=\overline{e}ⱼAⱼ(t)cos(wⱼt+φⱼ) (2)
where \overline{e}ⱼ represents a unit vector, and expresses the polarization state of the emitted wave, Aⱼ is associated with the amplitude of the wave as a function of time (envelope function) and φⱼ represents a phase term defined at the emission and specific to each of the emitters.

During propagation, each field accumulates phase, which may vary over the entire length of the path, reflecting the existence of turbulence phenomena and therefore fluctuations in the refractive index. As a result, the expression for the field, for each wave, becomes:
\overline{E}ⱼ=\overline{e}ⱼAⱼ(t)cos(ωⱼt+φⱼ+φ(x,y,z) (3)
where φ(x,y,z) is the phase accumulation term that depends on the spatial coordinates x, y and z. Let us consider that the two carrier waves are spectrally close. As a consequence, the phase accumulation term is identical for each of the optical carrier waves Wⱼ. This assumption remains valid as long as the dispersion of the propagation medium remains low, that is to say if there is no resonant absorption. Under these conditions, the degradation of the wave plane is similar in the two carrier waves.

In the optoelectronic detection means DET, the incident wave is the sum of the individual fields and the total optical intensity IT is written as:
I_{T}∝|\overline{E}₀+\overline{E}₁|² (4)
where \overline{E}₀ and \overline{E}₁ are given by equation (3).

This optical intensity generates a photocurrent i_{d} that has a temporal modulation term corresponding to the difference in the frequencies of each wave propagated:
i_{d}∝E₀²+E₁²+2E₀E₁cos((ω₀−ω₁)t+(φ₀−φ₁)+φ(x,y,z)−φ(x,y,z)) (5)
i.e.:
i_{d}∝E₀²+E₁²+2E₀E₁cos((ω₀−ω₁)t+(φ₀−φ₁)). (6)

With the system for transmission in free propagation mode according to the invention, a heterodyne-type setup is thus produced that makes it possible to autocompensate for the perturbations of the wave plane that are induced by the propagation medium. The technique proposed makes it possible in particular to produce a wide-field heterodyne function since perturbations of the wavefront that are due to the propagation have been circumvented, allowing the detection effectiveness to be increased.

Another advantage of the transmission system according to the invention relates to stability at emission. This is because all that is required is for the two emitters to follow the same frequency drift so that the frequency shift in the detection means is preserved.

Suitable filtering in the detection means DET then allows the component with the detection frequency Δv to be detected.

Advantageously, the detection means DET of the system according to the invention are equipped with a band-pass filter, the passband being centered on the detection frequency given by the difference between the frequencies of the carrier waves W₀ and W₁, making it possible to detect the modulation of the signal around said detection frequency. Using a microwave filter for example, the frequency difference Δv corresponds to a difference between the wavelengths of the two carrier waves ranging from a few tenths of a nanometer to a few nanometers. Typically, for a wavelength λ₀=10 μm of the carrier wave W₀ and a detection frequency Δv=10 GHz, the wavelength difference between the carrier waves must be 3.3 nm.

FIG. 3 shows, in a preferred example, the form of a microwave band-pass filter of the detection means. The spectral distribution (in arbitrary units a.u.) of the filter is plotted as a function of frequency (in Hz). The duration of an elementary bit of the digital data signal to be transmitted defines the width of the microwave filter to be used. In the example shown in FIG. 3, the spectral distribution is given by the equation (6) below:

$$S ( v ) = Δτ x sin {c}^{2} ( ( π v - \frac{Δ v}{2} ) Δτ ) \qquad ( 6 )$$

where Δτ represents the duration of a bit.

Thus, for a system operating at a rate of 1 Gbit per second (Δτ=1 ns) and for a detection frequency (or beat frequency), corresponding to the central frequency of the filter, of 10 GHz, the spectral distribution function shown in FIG. 3 is obtained.

In a variant, the filtering in the detection means may be active, by mixing with a microwave local oscillator at the frequency Δv. In this case, the signal at the frequency Δv output by the photodetector is mixed in a microwave mixer with a microwave local oscillator at a frequency v′. The output signal from the mixer, after filtering, is then a signal at the frequency v′−Δv (a low-frequency signal easy to filter out). However, it is necessary for Δv−v′>vₘ, where vₘ is the modulation frequency of the signal to be transmitted.

The encoding of the information may be transmitted in the following manner. If one of the two carrier waves is absent, or both of them, no signal is detected (the modulation term is zero in the equation (6) above), which corresponds to a <<0>>. However, it is sufficient that the two carrier waves emit simultaneously for a signal to be able to be detected, which will correspond to a binary 1. Thus, the modulation may be obtained by varying the intensity either of one of the carrier waves W₀ and W₁, or of both of them.

FIGS. 4 and 5 show two variants of the system for transmission in free propagation mode according to the invention.

FIG. 4 shows a diagram of an encrypted transmission system according to the invention. In this example, the aim is to transmit a signal output for example by an optical signal propagated along a transmission line by an optical fiber FBR and then converted by optoelectronic conversion means OE into a digital electrical signal Sᵢ(t). Assume, for example, that the emission means comprise at least two laser emitters LAS₀ and LAS₁ emitting two waves W₀ and W₁ of frequencies v₀ and v₁ respectively, the wave W₀ being a continuous wave and the wave W₁ being modulated by the data signal S₁(t). In this example, the transmission system includes means for the temporal variation of the frequency v₁ of the modulated wave W₁, causing a temporal variation of the detection frequency Δv(t)=v₁(t)−v₀ according to a predetermined law, said detection means DET being suitable for detection according to this law of variation. For example, the detection means are equipped with a band-pass filter, the passband of which is centered on a given detection frequency Δv₀. When the frequency difference Δv(t) is equal to Δv₀, the signal is a maximum; when this difference is far from Δv₀, the signal decreases. Thus, an encryption may be made by determining in the detection means what the frequency must be for the maximum signal to appear. In this way the information is encrypted, thereby helping to increase the security of the transmission system.

FIG. 5 illustrates the application of the transmission system according to the invention to a wavelength-multiplexed transmission. FIG. 5 illustrates the principle for the transmission of two digital data signals S₁(t) and S₂(t), but the principle may extend to a larger number of signals. In this example, the emission means comprise three independent laser emitters LAS₀, LAS₁, LAS₂, the emitter LAS₀ emitting a first, continuous light wave W₀ and the other two laser emitters emitting two light waves W₁, W₂ at two different optical frequencies v₁ and v₂, these two waves being modulated respectively by each of the signals to be transmitted. In this variant, the detection means are suitable for detection about each of the corresponding detection frequencies Δv₁=v₁−v₀ and Δv₂=v₂−v₀, for example by means of a band-pass filter having two windows centered on said detection frequencies. Of course, it is also possible to encrypt the data on the transmitted signals, as was described above.

Thus, the system for transmission in free propagation mode described in the invention allows heterodyne-type detection but with autocompensation of the turbulence effects, allowing more effective wide-field detection. This system takes advantage of the directivity properties associated with the optic and the gamut of signal processing techniques developed for microwaves.

Moreover, with the development of quantum cascade diodes, the spectral windows suitable for transmission in the atmosphere when it is foggy can be employed. Thus, the 3-5 μm and 10-12 μm spectral windows may be used. However, the higher the wavelength, the less the turbulence effects disturb the wave plane, thereby making it possible with the proposed setup to further increase the detection effectiveness.

1. A system for the optical transmission in free propagation mode of at least one digital data signal, comprising light emission means and optoelectronic detection means suitable for detection around at least one given non-zero detection frequency, wherein said emission means simultaneously emit, for each signal to be transmitted, two light waves at two different respective optical frequencies, at least one of said waves being intensity-modulated by said signal, and in that at least one of said detection frequencies is equal to the difference between said frequencies of the light waves emitted.

2. The transmission system as claimed in claim 1, wherein the two light waves are synchronized and intensity-modulated by said signal to be transmitted.

3. The transmission system as claimed in claim 1, wherein a first of said light waves is emitted continuously, the other being modulated by said signal to be transmitted.

4. The transmission system as claimed in claim 3, wherein it includes means for the temporal variation of the frequency of said modulated wave, causing a temporal variation of the detection frequency according to a predetermined law, said detection means being suitable for detection according to this law of variation.

5. The system for the transmission of at least two signals as claimed in claim 3, wherein the emission means emit a first, continuous light wave and at least two light waves at two different optical frequencies modulated respectively by each of the signals to be transmitted and in that the detection means are suitable for detection about each of the corresponding detection frequencies.

6. The transmission system as claimed in claim 1, wherein the emission means comprise at least two laser emitters emitting continuously, and the light emission intensity may be temporally modulated by an external electrical signal.

7. The transmission system as claimed in claim 6, wherein said emitters are laser diodes.

8. The transmission system as claimed in claim 1, wherein the emission means comprise at least one quantum cascade diode with two-frequency emission, the light emission intensity of which may be temporally modulated by an external electrical signal.

9. The transmission system as claimed in claim 1, wherein the detection means comprise means for band-pass filtering around said detection frequency or frequencies, the width of each band being defined by the duration of a bit of said signal to be transmitted.

10. The transmission system as claimed in claim 9, wherein the spectral distribution of said filter around a detection frequency is of the type:
S(v)=Δτ×sin c²((πvΔv/−2)Δτ)
where Δv is said detection frequency, Δτ is the duration of a bit of the signal to be transmitted, and v is the frequency.

11. The transmission system as claimed in claim 1, wherein the detection means comprise means for active filtering by mixing with a microwave local oscillator.

12. The system for the transmission of at least two signals as claimed in claim 4, wherein the emission means emit a first, continuous light wave and at least two light waves at two different optical frequencies modulated respectively by each of the signals to be transmitted and in that the detection means are suitable for detection about each of the corresponding detection frequencies.

13. The transmission system as claimed in claim 2, wherein the detection means comprise means for active filtering by mixing with a microwave local oscillator.

14. The transmission system as claimed in claim 3, wherein the detection means comprise means for active filtering by mixing with a microwave local oscillator.

15. The transmission system as claimed in claim 4, wherein the detection means comprise means for active filtering by mixing with a microwave local oscillator.

16. The transmission system as claimed in claim 5, wherein the detection means comprise means for active filtering by mixing with a microwave local oscillator.

17. The transmission system as claimed in claim 2, wherein the emission means comprise at least two laser emitters emitting continuously, and the light emission intensity may be temporally modulated by an external electrical signal.

18. The transmission system as claimed in claim 3, wherein the emission means comprise at least two laser emitters emitting continuously, and the light emission intensity may be temporally modulated by an external electrical signal.

19. The transmission system as claimed in claim 4, wherein the emission means comprise at least two laser emitters emitting continuously, and the light emission intensity may be temporally modulated by an external electrical signal.

20. The transmission system as claimed in claim 5, wherein the emission means comprise at least two laser emitters emitting continuously, and the light emission intensity may be temporally modulated by an external electrical signal.
